(19) United States
(12) Patent Application Publication
(10) Pub. No.: US 2003/0183450 A1
(43) Pub. Date: Oct. 2, 2003

(54) Gutter guard protector

(76) Inventor: Kevin Bonafide, Monmouth Beach, NJ (US)

Correspondence Address: CLIFFORD G. FRAYNE, Suite 7A, 136 Drum Point Road, Brick, NJ, 08723, US

(21) Appl. No.: 10/109,208

(22) Filed: Mar. 29, 2002

(51) Int. Cl. E06C 7/42

(52) U.S. Cl. 182/107

(57) ABSTRACT

A gutter guard of one piece construction, removably insertable into the gutter of a building to provide additional support when a ladder is juxtaposed thereto, the gutter guard being elongate in shape so as to span the distance between side rails of a ladder and in cross section, complimentary to the cross section of the gutter channel, the gutter guard having an overhanging lip for engagement with the under surface of the side rails of a ladder, the gutter guard serving to transfer the weight of the ladder and its user to the roof supports.

### RELATED APPLICATIONS

Applicant claims the benefit of provisional application 60/287,692 filed May 2, 2001.

### BACKGROUND OF THE INVENTION

1. Field of the Invention

The instant invention relates to drainage systems for roofs, and more particularly to a gutter guard which prevents damage to roof gutters when ladders are employed for roof work.

2. Description of the Prior Art

Drain systems for roofs, commonly referred to as gutters, catch the runoff of rain water from the roofs and direct it to downspouts, which in turn direct it away from the building foundation. The gutters which initially catch the rain water runoff from the roof are normally positioned along the horizontal span of the roof defined by the descending end of the roof truss and slightly below the roof overhang.

When access to the roof must be gained for certain purposes, such as reroofing or the like, it is along these portions of the roof that ladders are most likely placed. When access to the roof is intermittent and a ladder is used only occasionally, the gutters normally provide sufficient resistance so that they do not suffer damage. However, when repeated access is required, such as during a reroofing job where workers will utilize the ladder repeatedly, and in many instances will utilize the ladder repeatedly while carrying a heavy load, such as shingles, the gutter suffers damage in the form of denting, creasing or collapsing.

The present invention relates to a gutter guard which a roofer or other individual who is going to have to gain access to the roof on repeated occasions, can install on his first ascension to the roof. The gutter guard provides additional rigid support to the gutter to prevent its denting, creasing or crushing, and also provides a non-slip surface against which the ladder can rest during use.

### OBJECTS OF THE INVENTION

An object of the present invention is to provide for a novel gutter guard which is insertable into the gutter and presents the denting, creasing or crushing of the gutter when a ladder is juxtaposed thereto.

Another object of the present invention is to provide a gutter guard protector that is of one piece construction and be utilized with ladders of different widths.

A still further object of the present invention is to provide for a novel gutter guard which overhangs the lip of the gutter and provides a non-skid surface against which the ladder can rest.

### SUMMARY OF THE INVENTION

A gutter guard for providing additional support to the gutter and transfer of force when a ladder is juxtaposed thereto and also providing a non-skid surface for the ladder to rest against, the gutter guard having a lateral cross-section complimentary with the cross-sectional channel of the roof gutter, the rear wall of the gutter guard being dimensioned less than the rear wall of the gutter so as to permit the gutter guard to slip under the roof overhang, the front wall of the gutter guard having an extending lip beyond the front wall of the gutter guard to permit the ladder to be juxtaposed thereto, the length of the gutter guard being sufficient to span the width of the ladder juxtaposed thereto.

### BRIEF DESCRIPTION OF THE DRAWINGS

FIG. 1 is a perspective view of a typical roof gutter installation;

FIG. 2 is a perspective close up view of the gutter installation;

FIG. 3 is a perspective view of the gutter guard of the present invention;

FIG. 4 is an end view of a gutter guard of the present invention;

FIG. 5 is an end view of the gutter guard of the present invention shown installed in a typical roof gutter; and

### DETAILED DESCRIPTION OF THE DRAWINGS

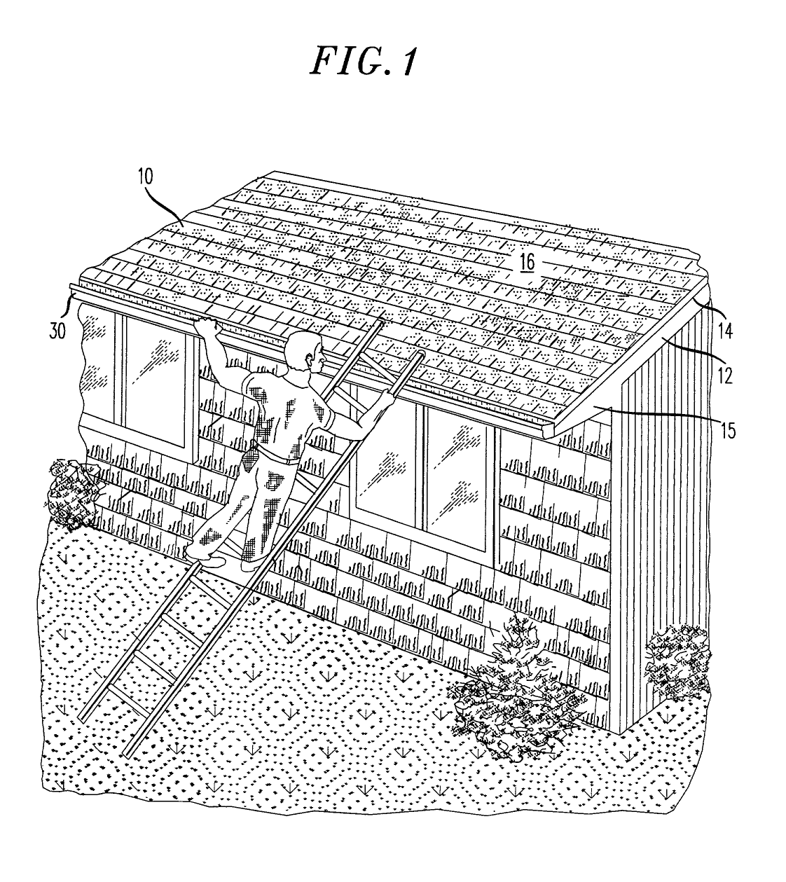

FIG. 1 is a perspective view of a typical roof gutter installation. The roof 10 consists of a plurality of a triangular shaped roof trusses 12 overlaid with sheathing 14, the sheathing consisting normally of three quarter inch plywood. The plywood sheathing 14 is overlaid with a vapor barrier (not shown) and is finally overlaid with a moisture barrier 16 in the form of shingles. The ends 15 of the trusses 12 are normally connected with a horizontal frame member as is the eave overhang. The lateral gutter 30 is attached to the planking securing the ends 15 of the trusses 12. As such it is positioned to accumulate and direct the rain water which runs off of the roof 10. The gutter may be slightly sloped in one direction or in two directions from its midpoint, where it terminates in a downspout (not shown) which directs the water downwardly and then away from the foundation of the building. The gutter 30 is normally formed of light gauge aluminum.

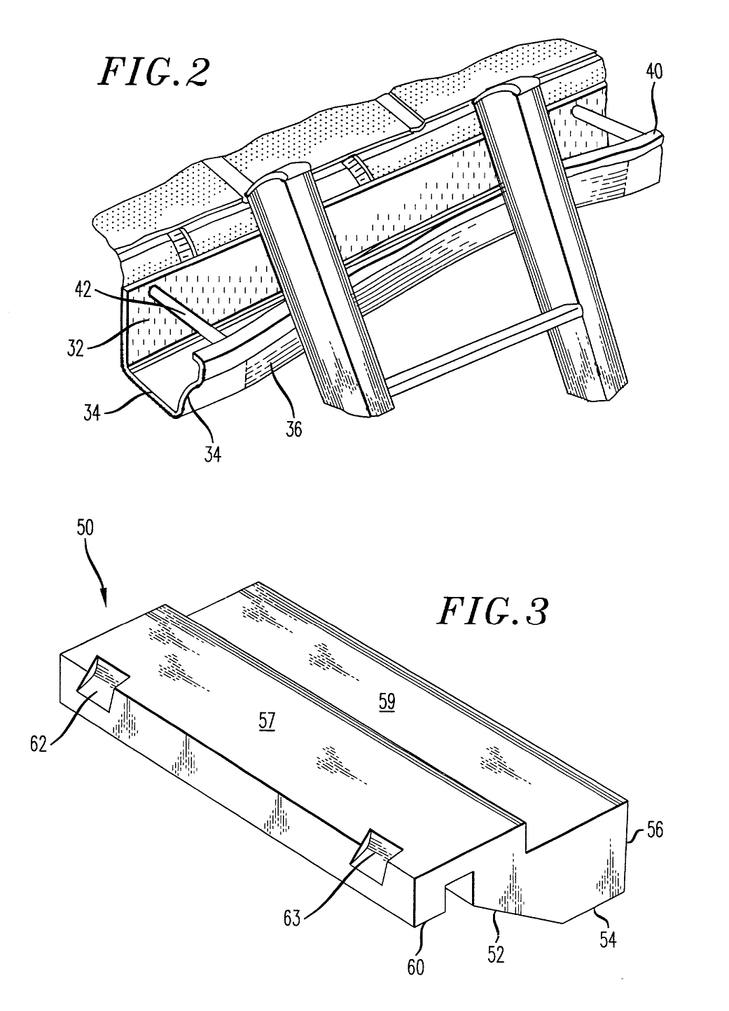

FIG. 2 is a perspective close up view of a portion of a typical lateral gutter 30. The gutter consists of a back wall 32, a bottom wall 34, and a front wall 36. The front wall has a generally arcuate portion 38 terminating with a lateral upper lip portion 40. In many instances, gutters are fabricated at the job site utilizing machines which are fed an elongate piece of aluminum which is folded in several steps by the machine which extrudes the gutter in the form heretofore described. In some instances, stiffeners 42 are spaced apart between the front wall and rear wall 36 and 32 respectively.

Despite the presence of the stiffeners, the juxtaposition of a ladder against the front wall 36 of the gutter 30, as illustrated in FIG. 2, and the repeated ascension and descension of the ladder as in a situation such as a reroofing job, the front wall 36 of the gutter 30 will crease, dent or deform. Oftentimes the outer surface of the front wall and bottom wall of the gutter are pigmented to compliment the exterior color of the house. The repetitive use of a ladder juxtaposed against the front wall 36 of gutter 30 can also result in the loss of this pigmentation and hence affect the aesthetics of the house.

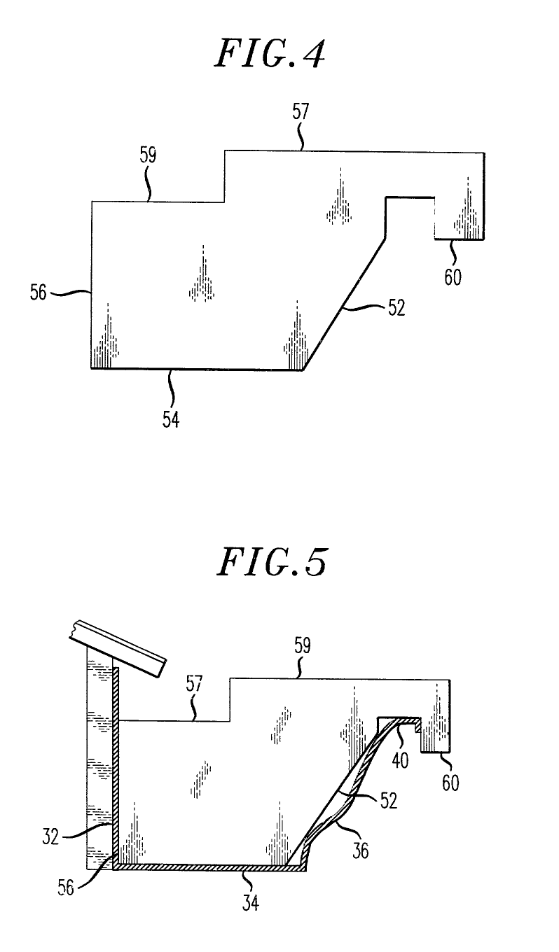

FIG. 3 is a perspective view of Applicant's gutter guard 50. FIG. 4 is a cross section view and FIG. 5 is a cross section of the gutter guard in engagement with the gutter. Gutter guard 50 is of one piece construction and is longitudinal in shape and dimensioned to slip into the U-shaped channel formed by the front wall 36, bottom wall 34, and rear wall 32 of gutter 30. Gutter guard 50 has a front wall 52 which conforms to the angle of the inner surface of front wall 36 of gutter 30. Gutter guard 50 has a lower surface 54 which conforms and is dimensioned to the inner surface of bottom wall 34 of gutter 30. The rear wall 56 of gutter guard 50 is juxtaposed the inner surface of rear wall 32 of gutter 30. The rear wall 56 of gutter guard 50 does not extend vertically, a distance equal to the vertical height of rear wall 32 of gutter 30 because in many instances, a portion of the roof sheathing or a portion of the lowest row of roof shingles extends over the rear wall 32 of gutter 30 (see FIG. 5). Hence gutter guard 50 is designed with a rear wall of less vertical dimension for those instances when it must be rotated into the gutter cavity when a portion of the roof extends over the rear wall 32 of gutter 30.

The front face 52 of gutter guard 50 terminates with a longitudinal overhanging lip portion 60 which is designed to extend over the lip portion 40 of front face 36 of gutter 30. This longitudinal lip 60 provides a pair of surfaces 62 and 63 on which the ladder rails would rest. Preferably surfaces 62 and 63 would be angled so as to provide a contact surface for the underside surface of the side rails of a ladder. This angle would be approximately 30 degrees. The top surface of gutter guard 50 is comprised of two generally planar stepped surfaces 57 and 59. Stepped surface 59 proximate the rear wall 56 of gutter guard 50 is lower than surface 57 in order to accommodate situations where there is a roof or shingle overhang as illustrated in FIG. 5.

As such it can be seen that the weight and force of the ladder rests upon this longitudinal lip with the body of the gutter guard 50 disposed within the C-shaped channel of the gutter provides reinforcement to the front face and transfers any load from the ladder to the back wall 32 of the gutter 30 which abuts the sheathing covering the ends of the roof trusses. Thus there can be no denting, creasing, or scraping of the gutter portion protected by the gutter guard. The one piece construction and continuous rear wall 56 juxtaposed rear wall 32 of gutter 30 insures that the load (man and ladder) is more evenly distributed to the truss ends of the roof structure.

The gutter guard could be fabricated of any suitable material, but a one piece molded, high density rubber or rubber-like material would be the preferred choice since the overhanging lip 60 of the gutter guard would then present a non-skid surface to the rails of the ladder, which would enhance the safety aspects of ladder use.

While the present invention has been described with respect to the exemplary embodiment thereof, it will be recognized by those of ordinary skill in the art that many modifications and changes can be made without departing from the spirit and scope of the invention. Therefore it is manifestly intended that the present invention be limited only by the scope of the claims and the equivalence thereof.

I claim:

1. A gutter guard protector in combination with a gutter for a roof on a building said gutter defined by a rear wall juxtaposed to said building, a bottom wall extending outwardly from said rear wall, and an angled front wall extending upward from said bottom wall thereby defining a channel, said gutter guard protector comprising a means insertable into said gutter for preventing top, side rail portions of a ladder from deforming said front wall of the gutter when placed against it, said insertable means comprising an elongate, one piece body member having an elongate dimension greater than the dimension between said side rails of said ladder, said elongate member defined by a planar rear surface juxtaposed said rear wall of said gutter;
a planar lower surface for juxtaposition against said bottom wall of said gutter, said planar lower surface dimensioned to extend from said back wall of said gutter to said front wall of said gutter;
a front surface, said front surface shaped to conform to said angled front wall of said gutter, said front face of said elongate member having an elongate lip member overhanging the front wall of said gutter;
an upper surface having a first planar surface defined by said lip member and a second lower planar surface proximate said rear face of said gutter permitting said elongate member to be removably insertable into said gutter channel.

2. The gutter guard protector in accordance with claim 1 wherein said elongate member has formed on said lip member proximate opposing ends of said lip member, an angled recess engageable with a portion of a ladder side rail to prevent slippage.

3. The gutter guard protector in accordance with claim 1 wherein said gutter guard protector is formed of one piece construction utilizing a non-slip rubber-like material.

4. The gutter guard protector in accordance with claim 1 wherein said elongate lip member on said front surface of said elongate member is formed with a continuous angle so as to engage an under surface of said side rails of said ladder.
